(19) United States
(12) Patent Application Publication
(10) Pub. No.: US 2025/0096436 A1
(43) Pub. Date: Mar. 20, 2025

(54) SECONDARY BATTERY

(71) Applicant: MURATA MANUFACTURING CO., LTD., Kyoto (JP)

(72) Inventor: Kenta HONDA, Kyoto (JP)

(21) Appl. No.: 18/960,870

(22) Filed: Nov. 26, 2024

Related U.S. Application Data
(63) Continuation of application No. PCT/JP2023/032395, filed on Sep. 5, 2023.

(30) Foreign Application Priority Data
Sep. 20, 2022 (JP) 2022-149244

(51) Int. Cl. H01M 50/56; H01M 50/107; H01M 50/152; H01M 50/531; H01M 50/562; H01M 50/588

(52) U.S. Cl. CPC H01M 50/56; H01M 50/107; H01M 50/152; H01M 50/531; H01M 50/562; H01M 50/588

(57) ABSTRACT

A secondary battery having higher safety is provided. The secondary battery includes a battery device, an outer package member, and an external terminal. The battery device includes a stacked body. The stacked body includes a first electrode and a second electrode, and is wound around a winding axis extending in a first direction. The outer package member has a through hole extending in the first direction, and contains the battery device. The external terminal is attached to the outer package member with an insulating member interposed between the external terminal and the outer package member. The external terminal is provided at a position at which the external terminal overlaps the through hole of the outer package member in the first direction. The external terminal has a curved shape including a concave surface or a convex surface facing toward the battery device.

The present application is a continuation of International patent application no. PCT/JP2023/032395, filed on Sep. 5, 2023, which claims priority to Japanese patent application no. 2022-149244, filed on Sep. 20, 2022, the entire contents of which are incorporated herein by reference.

### BACKGROUND

The present disclosure relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed including: an electrode body including a positive electrode body and a negative electrode body that are stacked or wound with a separator interposed therebetween; and an outer package casing containing the electrode body.

### SUMMARY

The present disclosure relates to a secondary battery.

Consideration has been given in various ways to improve performance of a secondary battery. However, there is room for improvement in terms of the performance of the secondary battery.

It is therefore desirable to provide a secondary battery having high safety.

A secondary battery according to an embodiment of the present disclosure includes a battery device, an outer package member, and an external terminal. The battery device includes a stacked body. The stacked body includes a first electrode and a second electrode, and is wound around a winding axis extending in a first direction. The outer package member has a through hole extending in the first direction, and contains the battery device. The external terminal is attached to the outer package member with an insulating member interposed between the external terminal and the outer package member. The external terminal is provided at a position at which the external terminal overlaps the through hole of the outer package member in the first direction. The external terminal has a curved shape including a concave surface or a convex surface facing toward the battery device.

According to the secondary battery of an embodiment of the present disclosure, the curved shape of the external terminal allows a pressure inside the battery to be more evenly applied to the external terminal. Accordingly, it is possible to achieve high safety.

Note that effects of the present disclosure are not necessarily limited to those described above and may include any of a series of effects described below in relation to the present disclosure.

### BRIEF DESCRIPTION OF THE FIGURES

FIG. 1 is a perspective diagram illustrating a configuration example of a secondary battery according to an embodiment of the present disclosure.

FIG. 2 is a sectional diagram illustrating the configuration example of the secondary battery illustrated in FIG. 1.

FIG. 3 is a sectional diagram illustrating a configuration example of a battery device illustrated in FIG. 2.

FIG. 4 is a sectional diagram illustrating a configuration example of an external terminal illustrated in FIG. 2.

FIG. 5 is a perspective diagram illustrating a configuration example of an outer package can to be used in a process of manufacturing the secondary battery.

FIG. 6 is a sectional diagram illustrating a configuration example of a secondary battery according to an embodiment.

FIG. 7 is a sectional diagram illustrating a configuration example of a secondary battery according to an embodiment.

FIG. 8 is a sectional diagram illustrating a configuration example of a secondary battery according to according to an embodiment.

FIG. 9 is a schematic sectional diagram illustrating a curving amount of an external terminal of Example.

FIG. 10A is a first explanatory diagram for describing a cleavage strength test on a sealed portion.

FIG. 10B is a second explanatory diagram for describing the cleavage strength test on the sealed portion.

### DETAILED DESCRIPTION

The present disclosure is described below in further detail including with reference to the drawings according to an embodiment.

A description is given first of a secondary battery according to an embodiment of the present disclosure.

The secondary battery to be described here has a flat and columnar three-dimensional shape, and is commonly referred to as, for example, a coin type or a button type. As will be described later, the secondary battery includes two bottom parts opposed to each other, and a sidewall part positioned between the two bottom parts. The secondary battery has a height smaller than an outer diameter. The term “outer diameter” refers to a diameter (a maximum diameter) of each of the two bottom parts. The term “height” refers to a distance (a maximum distance) from a surface of one of the bottom parts to a surface of another of the bottom parts. Note that, in the present embodiment, a direction from one of the bottom parts toward the other of the bottom parts is assumed to be a height direction Z.

Although a charge and discharge principle of the secondary battery is not particularly limited, the following description deals with a case where a battery capacity is obtained through insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

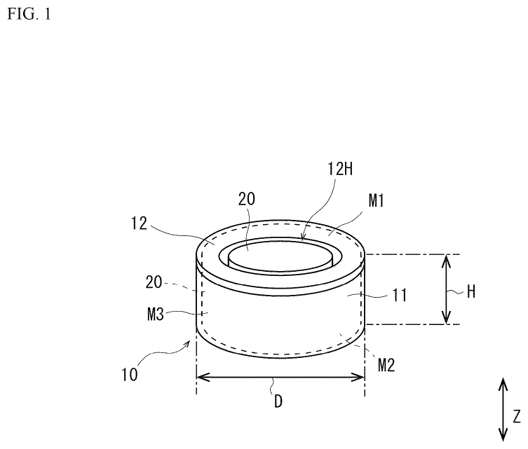

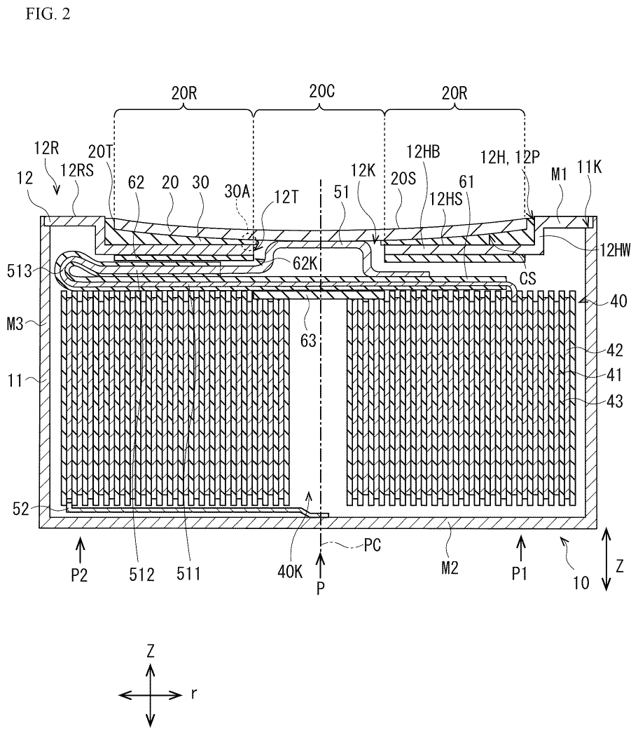

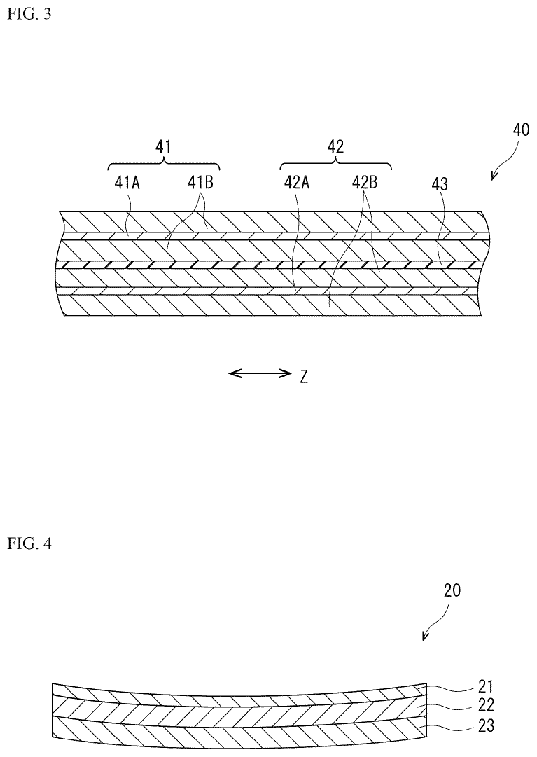

FIG. 1 illustrates a perspective configuration example of the secondary battery. FIG. 2 illustrates a sectional configuration example of the secondary battery illustrated in FIG. 1. FIG. 3 illustrates a sectional configuration example of a battery device 40 illustrated in FIG. 2. Note that FIG. 3 illustrates only a portion of the sectional configuration of the battery device 40 in an enlarged manner.

For convenience, the following description is given with an upper side of each of FIGS. 1 and 2 assumed to be an upper side of the secondary battery, and a lower side of each of FIGS. 1 and 2 assumed to be a lower side of the secondary battery.

The secondary battery to be described here has a three-dimensional shape in which a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar). Note that, in the present embodiment, an up-down direction in a sheet plane in each of FIGS. 1 and 2 is assumed to be the height direction Z. Accordingly, the height H means a dimension, of the secondary battery of the present embodiment, in the height direction Z. The outer diameter D means a dimension, of the secondary battery of the present embodiment, in a direction orthogonal to the height direction Z.

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. That is, the outer diameter D is greater than the height H. Although not particularly limited, an upper limit of the ratio D/H is preferably less than or equal to 25.

As illustrated in FIGS. 1 to 3, the secondary battery includes an outer package can 10, an external terminal 20, the battery device 40, and a positive electrode lead 51. Here, the secondary battery further includes a gasket 30, a negative electrode lead 52, a sealant 61, and insulating films 62 and 63.

As illustrated in FIGS. 1 and 2, the outer package can 10 is a hollow outer package member that contains the battery device 40 and other components. The outer package can 10 includes an electrically conductive material.

Here, the outer package can 10 has a flat and circular columnar three-dimensional shape corresponding to the three-dimensional shape of the secondary battery that is flat and circular columnar. Accordingly, the outer package can 10 includes two bottom parts M1 and M2 opposed to each other, and a sidewall part M3 positioned between the bottom parts M1 and M2. In other words, the sidewall part M3 couples the bottom part M1 and the bottom part M2 to each other, and surrounds the battery device 40. The sidewall part M3 has an upper end part coupled to the bottom part M1. The sidewall part M3 has a lower end part coupled to the bottom part M2. As described above, the outer package can 10 is substantially circular columnar. Thus, the bottom parts M1 and M2 are each substantially circular in plan shape, and a surface of the sidewall part M3 is a convexly curved surface.

The outer package can 10 includes a container part 11 and a cover part 12 that are welded to each other. In other words, an internal space of the outer package can 10 is sealed by the cover part 12 being welded to the container part 11. Note that, in the present embodiment, the bottom part M1 configures the cover part 12, and the bottom part M2 and the sidewall part M3 integrally configure the container part 11. Accordingly, an outer edge of the cover part 12 is welded to an end part, of the sidewall part M3, on an opposite side to the bottom part M2, i.e., the upper end part of the sidewall part M3.

The container part 11 is a container member that is to contain the battery device 40 and other components inside, and has a flat and circular columnar shape. The container part 11 has a hollow structure with an upper end part open and a lower end part closed. In other words, the container part 11 has an opening 11K (FIG. 2) at the upper end part. The opening 11K serves as a passing-through hole through which the battery device 40 is passable in the height direction Z.

As illustrated in FIG. 2, the cover part 12 is a substantially disk-shaped cover member that closes the opening 11K of the container part 11, and has a through hole 12K. The through hole 12K is used as a coupling path for coupling the battery device 40 and the external terminal 20 to each other. The outer edge of the cover part 12 is welded to the opening 11K of the container part 11, as described above. The external terminal 20 is attached to the cover part 12 with the gasket 30 interposed therebetween. That is, the cover part 12 supports the external terminal 20 with the gasket 30 interposed therebetween. The external terminal 20 is attached to the cover part 12 with the gasket 30 interposed therebetween, and is provided at a position at which the external terminal 20 overlaps the through hole 12K of the cover part 12 in the height direction Z. The external terminal 20 is electrically insulated from the outer package can 10.

In the secondary battery after completion, the cover part 12 is in a state of being welded to the container part 11 as described above. The opening 11K is closed with use of the cover part 12 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Thus, whether the container part 11 has had the opening 11K is recognizable afterward based on the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

The cover part 12 is so bent as to partly protrude along the height direction Z toward an inside of the container part 11 and thus forms a recessed part 12H. Specifically, as viewed from an outside of the outer package can 10, the cover part 12 is shaped to be partly recessed in the height direction Z toward the battery device 40 contained inside the outer package can 10. The recessed part 12H has the through hole 12K extending in the height direction Z, a bottom part 12HB surrounding the through hole 12K along a horizontal plane orthogonal to the height direction Z, and a wall part 12HW provided upright along an outer edge of the bottom part 12HB. A portion of the cover part 12 other than the recessed part 12H is a peripheral part 12R. The peripheral part 12R is provided to surround the recessed part 12H and has an annular shape in the horizontal plane orthogonal to the height direction Z of the secondary battery. The peripheral part 12R is a portion that surrounds a periphery of the recessed part 12H and protrudes away from the battery device 40 along the height direction Z. Accordingly, a surface 12HS of the bottom part 12HB of the recessed part 12H is at a low position in the height direction Z toward the inside of the container part 11 as compared with a surface 12RS of the peripheral part 12R. In other words, a distance between the surface 12HS of the bottom part 12HB of the recessed part 12H and the battery device 40 in the height direction Z is shorter than a distance between the surface 12RS of the peripheral part 12R and the battery device 40 in the height direction Z.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired. However, the depth of the recessed part 12H is set to allow a height position of a surface 20S of the external terminal 20 to be lower than a height position of the surface 12RS of the peripheral part 12R, in a state where the external terminal 20 is attached to the recessed part 12H with the gasket 30 interposed therebetween.

As described above, the outer package can 10 is what is called a welded can in which the container part 11 and the cover part 12 that have been physically separate from each other are welded to each other. Thus, the outer package can 10 after the welding is a single member that is physically integral as a whole, and is in a state of being not separable into the container part 11 and the cover part 12 afterward.

The outer package can 10 that is the welded can is different from a crimped can formed by crimping processing, and is what is called a crimples can. One reason for this is to increase a device space volume inside the outer package can 10 and to thereby increase an energy density per unit volume. The term “device space volume” refers to a volume (an effective volume) of the internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive. To be more specific, the container part 11 and the cover part 12 are each electrically conductive. The outer package can 10 is electrically coupled to a negative electrode 42 of the battery device 40 via the negative electrode lead 52. Accordingly, the outer package can 10 also serves as an external coupling terminal of the negative electrode 42. It is unnecessary for the secondary battery of the present embodiment to be provided with the external coupling terminal of the negative electrode 42 separate from the outer package can 10, which suppresses a decrease in the device space volume resulting from providing the external coupling terminal of the negative electrode 42. As a result, the device space volume increases, and the energy density per unit volume increases accordingly.

Specifically, the outer package can 10 is a metal can that includes any one or more of electrically conductive materials including, without limitation, a metal material and an alloy material. Examples of the electrically conductive material included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

The cover part 12 is insulated, via the gasket 30, from the external terminal 20 serving as an external coupling terminal of a positive electrode 41. One reason for this is to prevent contact, or a short circuit, between the outer package can 10 that is the external coupling terminal of the negative electrode 42 and the external terminal 20 that is the external coupling terminal of the positive electrode 41.

### [External Terminal]

As illustrated in FIGS. 1 and 2, the external terminal 20 is a coupling terminal to be coupled to electronic equipment when the secondary battery is mounted on the electronic equipment. As described above, the external terminal 20 is attached to the cover part 12 of the outer package can 10 to be supported by the cover part 12.

Here, the external terminal 20 is coupled to the positive electrode 41 of the battery device 40 via the positive electrode lead 51. The external terminal 20 thus also serves as the external coupling terminal of the positive electrode 41. Accordingly, upon use of the secondary battery, the secondary battery is coupled to the electronic equipment via the external terminal 20 serving as the external coupling terminal of the positive electrode 41 and the outer package can 10 serving as the external coupling terminal of the negative electrode 42. This allows the electronic equipment to operate with use of the secondary battery as a power source.

The external terminal 20 has a curved shape that is curved relative to the horizontal plane orthogonal to the height direction Z of the secondary battery. Specifically, as illustrated in FIG. 2, the external terminal 20 has a curved surface CS that is a convex surface protruding toward the battery device 40 and that is opposed to the battery device 40. The external terminal 20 is disposed inside the recessed part 12H with the gasket 30 interposed therebetween. That is, the external terminal 20 is provided in a state of being contained in the recessed part 12H without protruding from the recessed part 12H in the height direction Z. The curved surface CS is the convex surface that is so curved as to protrude the most and becomes the nearest to the battery device 40 at a center position of the external terminal 20 in a radial direction r, and as to allow a distance from the curved surface CS to the battery device 40 to increase from the center position of the external terminal 20 toward an outer edge 20T of the external terminal 20 in the radial direction r. The center position of the external terminal 20 corresponds to a center line PC to be described later of the secondary battery.

A shape of the external terminal 20 in a plan view, that is, a shape defined by an outer edge of the external terminal 20 when the secondary battery is viewed from above, is not particularly limited. In the secondary battery of the present embodiment, the shape of the external terminal 20 has a substantially circular shape in a plan view.

The external terminal 20 includes any one or more of electrically conductive materials including, without limitation, a metal material and an alloy material. The external terminal 20 may include, for example, a stacked body including two or more layers having respective linear expansion coefficients that are different from each other. Specifically, as illustrated in FIG. 4, the external terminal 20 includes a stacked body including a first layer 21 including Ni (nickel), a second layer 22 including stainless steel such as SUS304, and a third layer 23 including Al (aluminum). FIG. 4 is a sectional diagram illustrating a configuration example of the external terminal 20. Under an environment of a room temperature (20° C.), nickel has a linear expansion coefficient of about 13.3 [×10⁻⁶/° C.], SUS304 has a linear expansion coefficient of about 17.3 [×10⁻⁶/° C.], and aluminum has a linear expansion coefficient of about 23.9 [×10⁻⁶/C]. Note, however, that the external terminal 20 may be single-layered.

The external terminal 20 is insulated from the cover part 12 via the gasket 30. Here, as illustrated in FIG. 2, a position of the surface 20S of the external terminal 20, even the highest position of the surface 20S, is low in the height direction Z toward the battery device 40 as compared with a position of the surface 12RS of the peripheral part 12R of the outer package can 10 in the height direction Z. In the secondary battery of the present embodiment, the height of the secondary battery is reduced as compared with a case where the external terminal 20 protrudes above the cover part 12. This increases the energy density per unit volume of the secondary battery. This also makes it possible to prevent a short circuit between the outer package can 10 and the external terminal 20 from being caused by another electrically conductive member. The external terminal 20 has a middle region 20C, and a peripheral region 20R surrounding a periphery of the middle region. The middle region 20C is a part, of the external terminal 20, that overlaps the through hole 12K of the cover part 12. The positive electrode lead 51 is coupled to the middle region 20C. The peripheral region 20R overlaps the bottom part 12HB of the recessed part 12H in the height direction Z. Owing to the external terminal 20 and the cover part 12 having an overlap region, it is possible to improve mechanical strength of the secondary battery as a whole.

Note that the external terminal 20 has an outer diameter smaller than the inner diameter of the recessed part 12H. The external terminal 20 is thus spaced from the cover part 12 in a periphery of the external terminal 20. Accordingly, the gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. However, the gasket 30 may also be provided between an inner wall face of the wall part 12HW of the recessed part 12H and the outer edge 20T of the external terminal 20.

The gasket 30 is an insulating member disposed between the outer package can 10 (the cover part 12) and the external terminal 20, as illustrated in FIG. 2. The external terminal 20 is fixed to the cover part 12 with the gasket 30 interposed therebetween. The gasket 30 is ring-shaped in a plan view and has a through hole at a location corresponding to the through hole 12K. The gasket 30 includes any one or more of insulating materials including, without limitation, a polymer compound having an insulating property. The insulating materials are resins including, without limitation, polypropylene and polyethylene.

A range of placement of the gasket 30 is not particularly limited, and may be chosen as desired. Here, the gasket 30 is disposed in a gap between an upper surface of the cover part 12 and the curved surface CS as a lower surface of the external terminal 20, inside the recessed part 12H. However, as described above, the gasket 30 is preferably also provided between the inner wall face of the wall part 12HW of the recessed part 12H and the outer edge 20T of the external terminal 20. Further, the cover part 12 and the external terminal 20 are preferably stuck to each other by the gasket 30.

The gasket 30 includes a thin part 30A that is relatively smaller in thickness than another part in the radial direction r along the horizontal plane orthogonal to the height direction Z. The thin part 30A is present in an annular shape on the horizontal plane. In other words, in the gasket 30, the thin part 30A is provided isotropically around a center position of the secondary battery in the horizontal plane. In the secondary battery of the present embodiment, the thin part 30A is in the vicinity of an edge 12T, of the cover part 12, that forms the through hole 12K. In the secondary battery of the present embodiment, a thickness of the gasket 30 is the largest in a portion corresponding to the outer edge 20T of the external terminal 20, and gradually becomes smaller toward the center line PC that passes through the center position of the secondary battery in the horizontal plane. One reason for this is that the bottom part 12HB of the recessed part 12H extends along the horizontal plane, whereas the curved surface CS of the external terminal 20 protrudes downward.

The battery device 40 is a power generation device that causes charging and discharging reactions to proceed. As illustrated in FIGS. 2 and 3, the battery device 40 is contained inside the outer package can 10. The battery device 40 includes the positive electrode 41 as a first electrode and the negative electrode 42 as a second electrode. Here, the battery device 40 further includes a separator 43 and an electrolytic solution. The electrolytic solution is a liquid electrolyte.

The center line PC illustrated in FIG. 2 is a line segment corresponding to a center of the battery device 40 in a direction along the outer diameter D of the secondary battery (the outer package can 10). More specifically, a position P of the center line PC corresponds to a position of the center of the battery device 40.

The battery device 40 is what is called an electrode wound body. More specifically, in the battery device 40, the positive electrode 41 and the negative electrode 42 are stacked on each other with the separator 43 interposed therebetween. In addition, the stack of the positive electrode 41, the negative electrode 42, and the separator 43 is wound around the center line PC as a winding axis. The positive electrode 41 and the negative electrode 42 are wound, remaining in a state of being opposed to each other with the separator 43 interposed therebetween. As a result, a winding center space 40K as an internal space is present at the center of the battery device 40.

Here, the positive electrode 41, the negative electrode 42, and the separator 43 are so wound that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired.

The battery device 40 has a three-dimensional shape based on the three-dimensional shape of the outer package can 10. Specifically, the battery device 40 has a flat and circular columnar three-dimensional shape. This helps to prevent what is called a dead space, more specifically, a gap between the outer package can 10 and the battery device 40, from easily being provided when the battery device 40 is placed inside the outer package can 10, as compared with a case where the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

The positive electrode 41 is the first electrode to be used to cause the charging and discharging reactions to proceed. As illustrated in FIG. 3, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. One reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 42 is the second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A. The negative electrode active material layer 42B may further include other materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. One reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. One reason for this is to prevent precipitation of lithium extracted from the positive electrode 41. The term “height” refers to a dimension corresponding to the height H of the secondary battery described above, that is, a dimension in the up-down direction in each of FIGS. 1 and 2. The definition of the height described here applies also to the following.

The separator 43 is an insulating porous film interposed between the positive electrode 41 and the negative electrode 42, as illustrated in FIGS. 2 and 3. The separator 43 allows lithium ions to pass through the separator 43 and prevents a short circuit between the positive electrode 41 and the negative electrode 42. The separator 43 includes a polymer compound such as polyethylene.

Here, the separator 43 has a height greater than the height of the negative electrode 42. More specifically, the separator 43 preferably protrudes above the negative electrode 42 and protrudes below the negative electrode 42. One reason for this is to insulate the positive electrode lead 51 from the negative electrode 42 by using the separator 43.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is contained inside the outer package can 10. The positive electrode lead 51 is coupling wiring coupled to each of the positive electrode 41 and the external terminal 20. The secondary battery illustrated in FIG. 2 includes one positive electrode lead 51. However, the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to the lower surface of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 2, the positive electrode lead 51 includes a first part 511, a second part 512, and a turning part 513. The first part 511 and the second part 512 each extend along the horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other.

The first part 511 and the second part 512 are sandwiched between the battery device 40 and a protruding part 12P of the cover part 12 in the height direction Z of the secondary battery.

In this way, the portion of the positive electrode lead 51 is held by the cover part 12 and the battery device 40 by extending along each of a lower surface of the cover part 12 and an upper surface of the battery device 40. This allows the positive electrode lead 51 to be fixed inside the outer package can 10. By preventing the positive electrode lead 51 from easily moving even if the secondary battery experiences an external force such as vibration or impact, the positive electrode lead 51 is prevented from being easily damaged. Examples of damage to the positive electrode lead 51 referred to above include cracking of the positive electrode lead 51, breakage of the positive electrode lead 51, and detachment of the positive electrode lead 51 from the positive electrode 41.

More specifically, the wording “a portion of the positive electrode lead 51 is sandwiched by the outer package can 10 and the battery device 40” means that the positive electrode lead 51 is held by the outer package can 10 and the battery device 40 from above and below while being insulated from each of the outer package can 10 and the battery device 40, and that the positive electrode lead 51 is thus in a state of being not easily movable inside the outer package can 10 even if the secondary battery experiences an external force such as vibration or impact. The state where the positive electrode lead 51 is not easily movable inside the outer package can 10 exactly indicates that the battery device 40 is also in the state of being not easily movable inside the outer package can 10. This helps to also suppress a defect of the battery device 40, i.e., the wound electrode body, such as winding deformation when the secondary battery experiences vibration or impact.

Note that the positive electrode lead 51 may be in a state of being partially embedded in the battery device 40 because of being pressed by the battery device 40. More specifically, the positive electrode lead 51 may be in a state of being partially embedded in an upper end part of the separator 43 because of the height of the separator 43 being greater than the height of each of the positive electrode 41 and the negative electrode 42 as described above. In such a case, a recessed part is formed in the upper end part of the separator 43 because of being pressed by the positive electrode lead 51. All or a part of the positive electrode lead 51 is received in the recessed part, and the positive electrode lead 51 is held by the separator 43. The positive electrode lead 51 is prevented from easily moving inside the outer package can 10, and is thereby further prevented from being easily damaged.

Here, as described above, the cover part 12 includes the protruding part 12P, and a portion of the positive electrode lead 51 is sandwiched by the protruding part 12P and the battery device 40. More specifically, a portion of the positive electrode lead 51 is held by the protruding part 12P and the battery device 40 by extending along each of a lower surface of the protruding part 12P and the upper surface of the battery device 40. The protruding part 12P helps to hold the positive electrode lead 51 more easily. This further prevents the positive electrode lead 51 from being easily damaged.

Further, a portion of the positive electrode lead 51 is insulated from the cover part 12 and the negative electrode 42 via each of the separator 43, the sealant 61, and the insulating film 62.

Specifically, as described above, the height of the separator 43 is greater than the height of the negative electrode 42. Accordingly, a portion of the positive electrode lead 51 is separate from the negative electrode 42 via the separator 43, and is thus insulated from the negative electrode 42 via the separator 43. One reason for this is to prevent a short circuit between the positive electrode lead 51 and the negative electrode 42.

Further, the positive electrode lead 51 is covered at a periphery thereof by the sealant 61 having an insulating property. A portion of the positive electrode lead 51 is thus insulated from each of the cover part 12 and the negative electrode 42 via the sealant 61. One reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. A portion of the positive electrode lead 51 is thus insulated from the cover part 12 via the insulating film 62. One reason for this is to prevent a short circuit between the positive electrode lead 51 and the cover part 12.

In addition, an insulating film may also be disposed between the battery device 40 and the positive electrode lead 51.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

Here, the positive electrode lead 51 is coupled to the positive electrode 41 in a region on a front side relative to the center line PC, i.e., a region on a right side relative to the center line PC in FIG. 2. In order to be coupled to the external terminal 20, the positive electrode lead 51 includes the turning part 513 in the middle of extension to the external terminal 20. The turning part 513 is present in a region on a back side relative to the center line PC, i.e., a region on a left side relative to the center line PC in FIG. 2. The positive electrode lead 51 includes the first part 511 that corresponds to a part that lies from a location where the positive electrode lead 51 is coupled to the positive electrode 41, through the center position P, to the turning part 513. The first part 511 extends along the upper surface of the battery device 40 in a direction orthogonal to the height direction Z. In addition, the positive electrode lead 51 includes the second part 512 that corresponds to a part in the middle of extension from the turning part 513 to a location where the positive electrode lead 51 is coupled to the external terminal 20. The second part 512 extends along the upper surface of the battery device 40 in the direction orthogonal to the height direction Z in such a manner as to be laid over the first part 511. As described above, a portion of the positive electrode lead 51 is sandwiched by the cover part 12 and the battery device 40 and extends toward the external terminal 20, in both the region on the front side relative to the center line PC and the region on the back side relative to the center line PC.

Here, as is apparent from FIG. 2, “the region on the front side relative to the center line PC” is, where the battery device 40 is divided into two regions with respect to the center line PC in a direction along the outer diameter D, one region in which the location where the positive electrode lead 51 is coupled to the positive electrode 41 is present. In FIG. 2, “the region on the front side relative to the center line PC” is the region on the right side relative to the center line PC. In contrast, as is apparent from FIG. 2, “the region on the back side relative to the center line PC” is another region of the two regions, and is the region on the left side relative to the center line PC in FIG. 2. In other words, “the region on the back side relative to the center line PC” is, where the battery device 40 is divided into the two regions with respect to the center line PC in the direction along the outer diameter D, the other region in which the location where the positive electrode lead 51 is coupled to the positive electrode 41 is absent.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to an outermost wind of the positive electrode 41. One reason for this is that corrosion of the outer package can 10 caused by creeping up of the electrolytic solution is suppressed unlike when the positive electrode lead 51 is coupled to the positive electrode 41 in the outermost wind of the positive electrode 41. The wording “creeping up of the electrolytic solution” refers to a phenomenon in which, when the positive electrode lead 51 is disposed in proximity to an inner wall face of the outer package can 10, the electrolytic solution in the battery device 40 creeps up along the positive electrode lead 51 to reach the inner wall face of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the extending direction of the positive electrode lead 51 changes at an angle greater than 90° in the middle of the positive electrode lead 51. The positive electrode lead 51 preferably has, at a location where the positive electrode lead 51 is turned up, a curved shape rather than a bent shape, as with the turning part 513. Further, although FIG. 2 illustrates an example in which the positive electrode lead 51 includes one turning part 513, the positive electrode lead 51 may include multiple turning parts 513.

The positive electrode lead 51 is turned up at the turning part 513 in the middle of extension from the positive electrode 41 to the external terminal 20. Specifically, as illustrated in FIG. 2, the first part 511 extends from a first position P1 to a second position P2 in the horizontal plane orthogonal to the height direction of the secondary battery. The first position P1 is other than the center position P of the outer package can 10. The second position P2 is on an opposite side of the center position to the first position P1. The second part 512 extends from the second position P2 toward the center position P. In the positive electrode lead 51, an overlap region of the first part 511 and the second part 512 is a surplus portion. It can thus be said that the positive electrode lead 51 has a length margin in a longitudinal direction of the positive electrode lead 51.

This provides room to change orientation of the cover part 12 relative to the container part 11 when forming the outer package can 10 by using the container part 11 and the cover part 12 in a process of manufacturing the secondary battery, as will be described later. Further, when the secondary battery experiences an external force such as vibration or impact, the length margin of the positive electrode lead 51 is usable to mitigate the external force, thereby helping to prevent the positive electrode lead 51 from being easily damaged. Furthermore, the length margin of the positive electrode lead 51 is usable to change the position of coupling of the positive electrode lead 51 to the positive electrode 41 to a desired position without changing the positive electrode lead 51 in length.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. One reason for this is to ensure that the length of the positive electrode lead 51 has a length margin allowing for raising the cover part 12 relative to the container part 11, and to thereby make it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from easily becoming detached from the external terminal 20 and be narrow enough to allow for the length margin of the positive electrode lead 51, in particular. One reason why the range of coupling of the positive electrode lead 51 to the external terminal 20 is preferably narrow enough is that a sufficiently large length margin of the positive electrode lead 51 is achievable because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is contained inside the outer package can 10. The negative electrode lead 52 is coupled to each of the negative electrode 42 and the outer package can 10 (the container part 11). Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. Details of a method of coupling the negative electrode lead 52 are similar to the details of the method of coupling the positive electrode lead 51.

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

A position of coupling of the negative electrode lead 52 to the negative electrode 42 is not particularly limited, and may be chosen as desired. Here, the negative electrode lead 52 is coupled to an outermost wind part of the negative electrode 42 included in the wound electrode body.

Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

The sealant 61 is a first insulating member covering the periphery of the positive electrode lead 51, as illustrated in FIG. 2. The sealant 61 includes two insulating tapes each being attached to corresponding one of a front surface and a back surface of the positive electrode lead 51. Here, to allow the positive electrode lead 51 to be coupled to each of the positive electrode 41 and the external terminal 20, the sealant 61 covers the periphery of a portion in the middle of the positive electrode lead 51. Note that a structure of the sealant 61 is not limited to a tape-shaped structure, and the sealant 61 may have a tube-shaped structure, for example.

The sealant 61 includes any one or more of insulating materials including, without limitation, a polymer compound having an insulating property. Examples of the insulating materials include polyimide.

The insulating film 62 is disposed between the cover part 12 and the positive electrode lead 51 in the height direction Z, as illustrated in FIG. 2. Here, the insulating film 62 is ring-shaped in a plan view and has an opening 62K at a location corresponding to the through hole 12K in the height direction Z.

The insulating film 62 may have an unillustrated adhesive layer on one surface, and may thus be adhered to either the cover part 12 or the positive electrode lead 51 via the adhesive layer. Alternatively, the insulating film 62 may have respective adhesive layers on both surfaces, and may thus be adhered to both the cover part 12 and the positive electrode lead 51 via the respective adhesive layers.

The insulating film 62 may include any one or more of insulating materials including, without limitation, a polymer compound having an insulating property. Examples of the one or more insulating materials to be included in the insulating film 62 include polyimide.

The insulating film 63 is a third insulating member disposed between the battery device 40 and the positive electrode lead 51, as illustrated in FIG. 2. Here, the insulating film 63 is flat plate-shaped in a plan view. The insulating film 63 is disposed to close the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same as or different from each other.

Note that the secondary battery may further include one or more other components.

Specifically, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include the occurrence of a short circuit inside the secondary battery and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, and more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 through the electrolytic solution. Upon discharging of the secondary battery, in the battery device 40, lithium is extracted from the negative electrode 42, and the extracted lithium is inserted into the positive electrode 41 through the electrolytic solution. Upon charging and discharging, lithium is inserted and extracted in an ionic state.

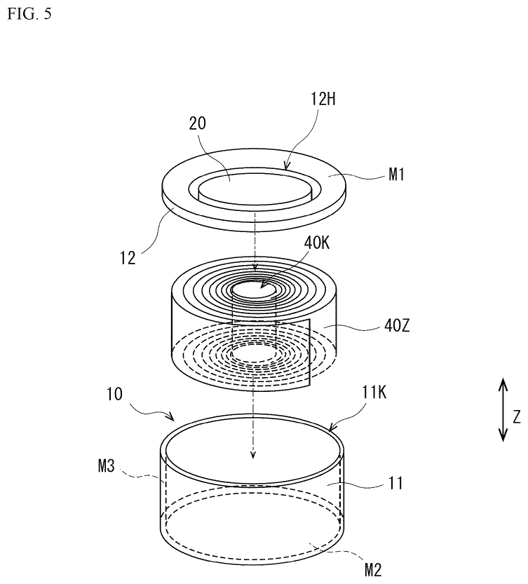

FIG. 5 illustrates a perspective configuration of the outer package can 10 to be used in the process of manufacturing the secondary battery, and corresponds to FIG. 1.

FIG. 5 illustrates a state where the cover part 12 is separate from the container part 11 before the cover part 12 is welded to the container part 11.

In the following description, where appropriate, FIGS. 1 to 4 described already will be referred to in conjunction with FIG. 5.

Here, as illustrated in FIG. 5, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby produce a positive electrode mixture. Thereafter, the positive electrode mixture thus produced is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated by a procedure similar to the fabrication procedure of the positive electrode 41. Specifically, the negative electrode current collector 42A is prepared, following which a negative electrode mixture in which the negative electrode active material and other materials including, without limitation, the negative electrode active material, and the negative electrode conductor are mixed with each other is put into an organic solvent to thereby prepare a negative electrode mixture slurry in paste form. As for the negative electrode current collector 42A, opposite end parts in a width direction of the negative electrode current collector 42A are slightly bent in the same direction to thereby form an upper end part 42U and a lower end part 42L. Thereafter, the negative electrode mixture slurry is applied on the two opposed surfaces of the negative electrode current collector 42A to thereby form the negative electrode active material layers 42B. Thereafter, the negative electrode active material layers 42B are compression-molded by, for example, a roll pressing machine. In this manner, the negative electrode 42 is fabricated.

The electrolyte salt is put into the solvent. The electrolyte salt is thereby dispersed or dissolved in the solvent. As a result, the electrolytic solution is prepared.

First, by the welding method such as the resistance welding method, the positive electrode lead 51 covered at the periphery thereof by the sealant 61 is coupled to the positive electrode 41 (the positive electrode current collector 41A), and the negative electrode lead 52 is coupled to the negative electrode 42 (the negative electrode current collector 42A).

Thereafter, the positive electrode 41 and the negative electrode 42 are stacked on each other with the separator 43 interposed between the positive electrode 41 and the negative electrode 42, following which the stacked body including the positive electrode 41, the negative electrode 42, and the separator 43 is wound to thereby fabricate a wound body 40Z, as illustrated in FIG. 4. The wound body 40Z has a configuration similar to the configuration of the battery device 40 except that the positive electrode 41, the negative electrode 42, and the separator 43 are each unimpregnated with the electrolytic solution. Note that FIG. 4 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In this case, the negative electrode lead 52 is coupled to the container part 11 by the welding method such as the resistance welding method. Thereafter, the insulating film 63 is placed on the wound body 40Z.

Thereafter, the cover part 12 to which the external terminal 20 is attached in advance with the gasket 30 being interposed between the cover part 12 and the external terminal 20 and on which the insulating film 62 is provided in advance is prepared, following which the positive electrode lead 51 is coupled to the external terminal 20 through the through hole 12K by the welding method such as the resistance welding method. Note that employing the stacked body including two or more layers having respective linear expansion coefficients that are different from each other as the external terminal 20 makes it possible for the external terminal 20 to be easily formed into a curved shape as illustrated in FIG. 4, when the positive electrode lead 51 is to be coupled to the external terminal 20 by a welding method. One reason for this is that the layers are allowed to exhibit different expansion rates by heat applied to the external terminal 20 upon the welding.

As a result, the wound body 40Z (the positive electrode 41) contained inside the container part 11 and the external terminal 20 attached to the cover part 12 are coupled to each other via the positive electrode lead 51.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. Thus, the battery device 40, i.e., the wound electrode body, is fabricated.

Thereafter, the cover part 12 is brought down into close proximity to the container part 11 to thereby close the opening 11K with the cover part 12, following which the cover part 12 is welded to the container part 11 by the welding method such as the laser welding method. In this case, as illustrated in FIG. 2, a portion of the positive electrode lead 51 is sandwiched between the cover part 12 and the battery device 40, and the turning part 513 that is curved is formed on the back side relative to the location where the positive electrode lead 51 is coupled to the external terminal 20. In this manner, the outer package can 10 is formed, and the battery device 40 and other components are contained inside the outer package can 10. Assembly of the secondary battery is thus completed.

The assembled secondary battery is charged and discharged. Various conditions including, for example, an environment temperature, the number of times of charging and discharging (the number of cycles), and charging and discharging conditions may be set as desired. As a result, a film is formed on a surface of, for example, the negative electrode 42. This brings the secondary battery into an electrochemically stable state. As a result, the secondary battery is completed.

As described above, according to the secondary battery of the present embodiment, the external terminal 20 has the curved shape including the curved surface CS that is the convex surface facing toward the battery device 40. The curved shape of the external terminal 20 makes it possible to quickly separate (i.e., open) the external terminal 20 from the cover part 12 and reduce an internal pressure when a pressure inside the secondary battery rises, while sealing the battery device 40 inside the outer package can 10 during normal use. One reason for this is that the curved shape of the external terminal 20 allows the pressure inside the battery to be more evenly applied to the external terminal 20. Therefore, it is possible to reduce variation in a pressure value of the pressure inside the battery when the external terminal 20 opens. In other words, the external terminal 20 opens more reliably when the pressure value substantially reaches a certain value. Accordingly, it is possible to achieve high safety.

Further, in the secondary battery of the present embodiment, the external terminal 20 may include the stacked body including two or more layers having respective linear expansion coefficients that are different from each other. This makes it possible to easily form a desired curved shape when the positive electrode lead 51 is to be coupled to the external terminal 20 by the welding method.

Further, in the secondary battery of the present embodiment, the external terminal 20 is contained in the recessed part 12H without protruding from the recessed part 12H in the height direction Z, which makes it possible to reduce the height of the secondary battery as compared with the case where the external terminal 20 protrudes above the cover part 12. This increases the energy density per unit volume of the secondary battery. This also makes it possible to prevent a short circuit between the outer package can 10 and the external terminal 20 from being caused by another electrically conductive member.

Further, in the secondary battery of the present embodiment, the gasket 30 includes the thin part 30A that is relatively smaller in thickness than another part in the radial direction r along the horizontal plane orthogonal to the height direction Z. Therefore, the external terminal 20 easily opens stably from the thin part 30A when the pressure inside the secondary battery rises. In particular, the thin part 30A may be present in the annular shape around the center line PC in the horizontal plane. This makes it possible to open the external terminal 20 with high reproducibility when the pressure inside the battery reaches a predetermined pressure value.

Further, in the secondary battery of the present embodiment, the recessed part 12H has the through hole 12K extending in the height direction Z, and the bottom part 12HB surrounding the through hole 12K along the horizontal plane orthogonal to the height direction Z. A portion of the external terminal 20 overlaps the bottom part 12HB of the recessed part 12H in the height direction Z. As described above, the secondary battery of the present embodiment includes the overlap region of the external terminal 20 and the cover part 12. This makes it possible to improve mechanical strength of the secondary battery as a whole. In particular, when the length, of the overlap region of the external terminal 20 and the bottom part 12HB, along the horizontal plane orthogonal to the height direction Z is greater than a thickness of the external terminal 20 and is greater than a thickness of the bottom part 12HB, the mechanical strength of the secondary battery is further improved.

Further, in the secondary battery of the present embodiment, the gasket 30 including an insulating resin is also provided between the inner wall face of the recessed part 12H and the outer edge 20T of the external terminal 20. This makes it possible to prevent a foreign material from entering a gap between the inner wall face of the recessed part 12H and the outer edge 20T of the external terminal 20, and to sufficiently prevent a short circuit between the cover part 12 and the external terminal 20.

Further, in the secondary battery of the present embodiment, the cover part 12 and the external terminal 20 are stuck to each other by the gasket 30 including the insulating resin. It is thus possible to increase mechanical strength against vibration. This makes it possible to prevent a short circuit caused by entry of a foreign material into the gap between the recessed part 12H and the external terminal 20.

Further, in the secondary battery of the present embodiment, the turning part 513 is positioned at the peripheral part 12R of the cover part 12, and the first part 511 and the second part 512 extend in a radial direction of the secondary battery from the center position of the secondary battery toward the peripheral part 12R. Specifically, the first part 511 extends from the first position P1 to the second position P2 in the horizontal plane orthogonal to the height direction Z of the secondary battery. The first position P1 is other than the center position P of the outer package can 10, and the second position P2 is on the opposite side of the center position P to the first position P1. The second part 512 extends from the second position P2 toward the center position. The overlap region of the first part 511 and the second part 512 is sandwiched and held by the protruding part 12P and the battery device 40. This helps to ensure that the first part 511 is in contact with the battery device 40 over a larger area with the sealant 61 interposed between the first part 511 and the battery device 40, and that the second part 512 is in contact with the recessed part 12H over a larger area directly or with the sealant 61 interposed between the second part 512 and the recessed part 12H. Accordingly, movements of the positive electrode lead 51 and the battery device 40 inside the outer package can 10 are sufficiently limited. This helps to prevent a defect, such as damage to the positive electrode lead 51 or winding deformation of the battery device 40, from easily occurring even when the secondary battery experiences impact or vibration. The secondary battery of the present embodiment thus makes it possible to achieve superior physical durability.

For example, the above-described action and effects are achievable by the secondary battery of the present embodiment for reasons described below.

The secondary battery of the present embodiment, which is referred to as, for example, the coin type or the button type, that is, the secondary battery having the flat and columnar three-dimensional shape, includes the external terminal 20 that is small in size and serves as the external coupling terminal of the positive electrode 41, as is apparent from FIGS. 1 and 2. In this case, the external terminal 20 having the small size results in a small coupling area of the positive electrode lead 51 to the external terminal 20. Accordingly, it is necessary to sufficiently fix the positive electrode lead 51 inside the outer package can 10 in order to maintain the state where the external terminal 20 and the positive electrode lead 51 are electrically coupled to each other.

In this regard, in the secondary battery of the present embodiment, the movement of the positive electrode lead 51 inside the outer package can 10 is sufficiently suppressed. Accordingly, even if the coupling area of the positive electrode lead 51 to the external terminal 20 is small, it is highly unlikely that the positive electrode lead 51 will become detached from the external terminal 20 or be broken. The secondary battery of the present embodiment thus makes it possible to favorably maintain the state where the external terminal 20 and the positive electrode lead 51 are electrically coupled to each other, even when the secondary battery experiences an external force such as vibration or impact. It is therefore possible, with the secondary battery of the present embodiment, to achieve high physical durability even if the secondary battery is reduced in size.

Further, in the secondary battery of the present embodiment including the small-sized external terminal 20 serving as the external coupling terminal of the positive electrode 41, the cover part 12 of the outer package can 10 serving as the external coupling terminal of the negative electrode 42 is disposed in proximity to the external terminal 20, as is apparent from FIG. 2. In other words, the cover part 12 and the external terminal 20 which are two external coupling terminals having respective polarities different from each other are located close to each other. Accordingly, to prevent a short circuit between the cover part 12 and the external terminal 20, it is desirable that the coupling area of the positive electrode lead 51 to the external terminal 20 be sufficiently made small and that the positive electrode lead 51 be located sufficiently away from the cover part 12.

In this regard, in the secondary battery of the present embodiment, the movement of the positive electrode lead 51 inside the outer package can 10 is sufficiently suppressed. Accordingly, even if the coupling area of the positive electrode lead 51 to the external terminal 20 is small, it is highly unlikely that the positive electrode lead 51 will become detached from the external terminal 20 or be broken. The secondary battery of the present embodiment thus makes it possible to favorably maintain the state where the external terminal 20 and the positive electrode lead 51 are electrically coupled to each other, even when the secondary battery experiences an external force such as vibration or impact. It is therefore possible, with the secondary battery of the present embodiment, to achieve high physical durability while preventing a short circuit between the cover part 12 and the external terminal 20, even if the secondary battery is reduced in size.

Further, the height of the separator 43 having an insulating property may be greater than the height of the negative electrode 42, and a portion of the positive electrode lead 51 may be insulated from the negative electrode 42 via the separator 43. In such a case, a short circuit between the positive electrode lead 51 and the negative electrode 42 is prevented, and accordingly, it is possible to achieve higher reliability.

In this case, the positive electrode 41 and the negative electrode 42 may be wound, being opposed to each other with the separator 43 interposed between the positive electrode 41 and the negative electrode 42. In addition, the positive electrode lead 51 may be coupled to the positive electrode 41 on the inner side of the winding of the positive electrode 41 relative to the outermost wind of the positive electrode 41. In such a case, corrosion of the outer package can 10 resulting from creeping up of the electrolytic solution is suppressed. Accordingly, it is possible to achieve even higher reliability.

Further, the sealant 61 may cover the periphery of the positive electrode lead 51, and a portion of the positive electrode lead 51 may be insulated from each of the outer package can 10 and the negative electrode 42 via the sealant 61. In such a case, a short circuit between the positive electrode lead 51 and the outer package can 10 is prevented, and a short circuit between the positive electrode lead 51 and the negative electrode 42 is also prevented. Accordingly, it is possible to achieve higher reliability.

In this case, in particular, covering the periphery of the positive electrode lead 51 with the sealant 61 provides the following action and effects. When the positive electrode lead 51 is sandwiched by the outer package can 10 and the battery device 40 with the sealant 61 interposed between the positive electrode lead 51 and each of the outer package can 10 and the battery device 40, a grip force is generated between the outer package can 10 and the sealant 61, and also between the battery device 40 and the sealant 61. As a result, it becomes easier for the positive electrode lead 51 to be held by the outer package can 10 and the battery device 40 with the help of the grip force supplied to the positive electrode lead 51 via the sealant 61. As a result, the positive electrode lead 51 is insulated from the outer package can 10 and the negative electrode 42 via the sealant 61. In addition, it becomes further easier for the positive electrode lead 51 to be fixed inside the outer package can 10 with the help of the sealant 61. This makes it possible to achieve even higher physical durability.

Further, the insulating film 62 may be disposed between the outer package can 10 and the positive electrode lead 51, and a portion of the positive electrode lead 51 may be insulated from the outer package can 10 via the insulating film 62. In such a case, a short circuit between the positive electrode lead 51 and the outer package can 10 is prevented. Accordingly, it is possible to achieve higher reliability.

Further, the insulating film 63 may be disposed between the battery device 40 and the positive electrode lead 51, and a portion of the positive electrode lead 51 may be insulated from the negative electrode 42 via the insulating film 63. In such a case, a short circuit between the positive electrode lead 51 and the negative electrode 42 is prevented. Accordingly, it is possible to achieve higher reliability.

Further, the outer package can 10 includes the container part 11 and the cover part 12 that are welded to each other, and the positive electrode lead 51 is turned up once or more, which provides the length margin of the positive electrode lead 51. It thus becomes possible to raise the cover part 12 relative to the container part 11 in the process of manufacturing the secondary battery, particularly in a process of forming the outer package can 10. This allows for easy injection of the electrolytic solution, and furthermore, allows for changing the position of coupling of the positive electrode lead 51 to the positive electrode 41 as desired. Accordingly, it is possible to achieve higher easiness of manufacture.

Further, the secondary battery may have the flat and columnar shape, that is, the secondary battery may be a secondary battery that is referred to as, for example, the coin type or the button type. In such a case, the positive electrode lead 51 is prevented from being easily damaged even in a small-sized secondary battery that is highly constrained in terms of size. Accordingly, it is possible to achieve higher effects in terms of physical durability.

Further, the secondary battery may be a lithium-ion secondary battery. In such a case, it is possible to stably obtain a sufficient battery capacity through the use of insertion and extraction of lithium.

The configuration of the secondary battery described above is appropriately modifiable as described below according to an embodiment. Note that any two or more of the following series of modification examples may be combined with each other.

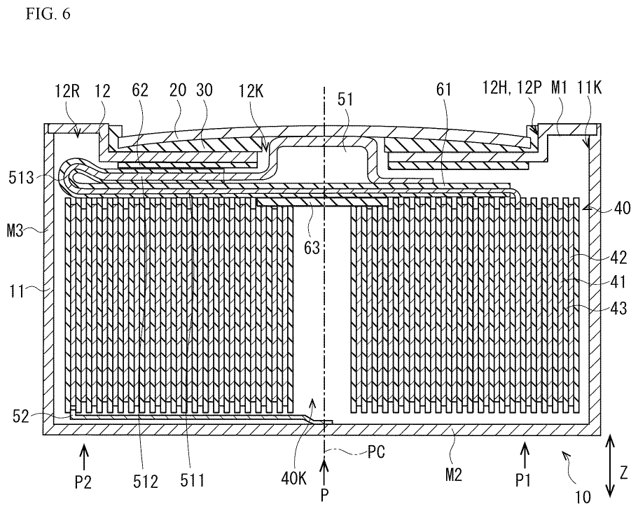

FIG. 6 illustrates a sectional configuration of a secondary battery of Modification example 1 of the above-described embodiment. FIG. 2 illustrates an example case of the secondary battery in which the curved surface CS, of the external terminal 20, that is opposed to the battery device 40 is the convex surface. However, in the secondary battery of the present present disclosure, the curved surface CS, of the external terminal 20, that is opposed to the battery device 40 may be a concave surface, as illustrated in FIG. 6. In this case also, it is possible to achieve effects similar to the effects of the secondary battery according to the above-described embodiment.

Note that, in Modification example 1 also, the external terminal 20 is contained in the recessed part 12H without protruding from the recessed part 12H in the height direction Z, as illustrated in FIG. 6, which makes it possible to reduce the height of the secondary battery. In this case, the energy density per unit volume of the secondary battery is increased. This also makes it possible to prevent a short circuit between the outer package can 10 and the external terminal 20 from being caused by another electrically conductive member.

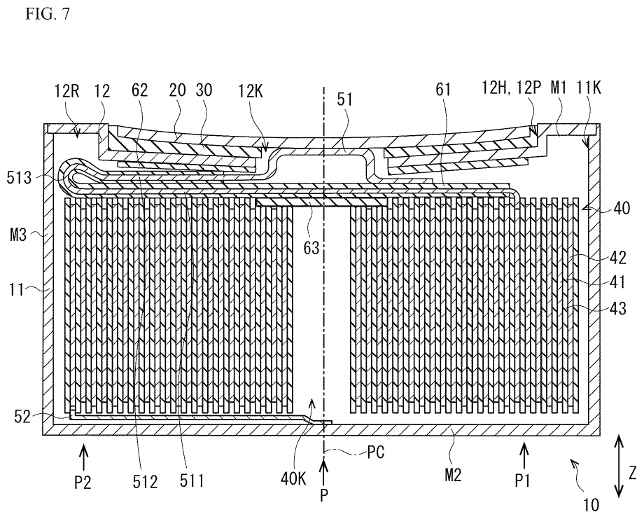

FIG. 7 illustrates a sectional configuration of a secondary battery of Modification example 2 of the above-described embodiment. In the secondary battery of FIG. 2, the bottom part 12HB as the overlap region that overlaps the peripheral region 20R of the external terminal 20 with the gasket 30 interposed between the bottom part 12HB and the peripheral region 20R extends along the horizontal plane. In contrast, in the secondary battery of Modification example 2, the bottom part 12HB is inclined relative to the horizontal plane, along with the curved shape of the external terminal 20. Accordingly, in the secondary battery of Modification example 2, a distance between the external terminal 20 and the bottom part 12HB in the height direction Z is substantially constant. As a result, the thickness of the gasket 30 is also maintained to be substantially constant from the outer edge 20T of the external terminal 20 toward the center line PC. Except for those described above, a configuration of the secondary battery of Modification example 2 is substantially the same as the configuration of the secondary battery illustrated in FIG. 2.

In the secondary battery of Modification example 2 also, the external terminal 20 has the curved shape including the curved surface CS that is the convex surface facing toward the battery device 40. This allows the pressure inside the battery to be more evenly applied to the external terminal 20. Therefore, it is possible to reduce variation in a pressure value of the pressure inside the battery when the external terminal 20 opens. In other words, the external terminal 20 opens more reliably when the pressure value substantially reaches a certain value. Accordingly, it is possible to achieve high safety.

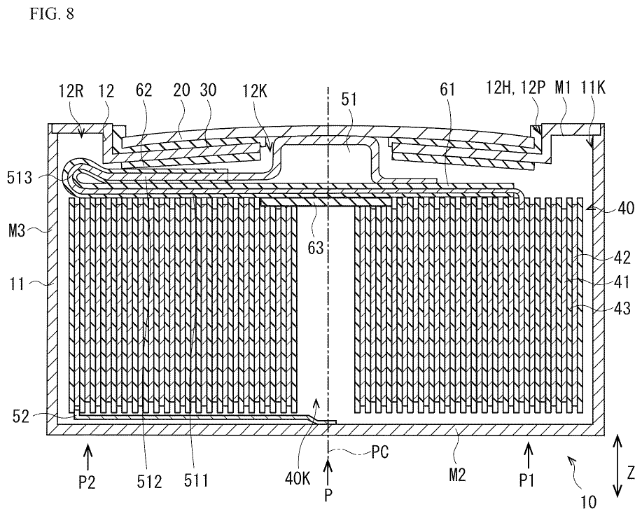

FIG. 8 illustrates a sectional configuration of a secondary battery of Modification example 3 of the above-described embodiment. In the secondary battery of Modification example 1 illustrated in FIG. 6, the bottom part 12HB as the overlap region that overlaps the peripheral region 20R of the external terminal 20 with the gasket 30 interposed between the bottom part 12HB and the peripheral region 20R extends along the horizontal plane. In contrast, in the secondary battery of Modification example 3, the bottom part 12HB is inclined relative to the horizontal plane, along with the curved shape of the external terminal 20. Accordingly, in the secondary battery of Modification example 3, the distance between the external terminal 20 and the bottom part 12HB in the height direction Z is substantially constant. As a result, the thickness of the gasket 30 is also maintained to be substantially constant from the outer edge 20T of the external terminal 20 toward the center line PC. Except for those described above, a configuration of the secondary battery of Modification example 3 is substantially the same as the configuration of the secondary battery of Modification example 1 illustrated in FIG. 6.

In the secondary battery of Modification example 3 also, the external terminal 20 has the curved shape including the curved surface CS that is the concave surface facing toward the battery device 40. This allows the pressure inside the battery to be more evenly applied to the external terminal 20. Therefore, it is possible to reduce variation in a pressure value of the pressure inside the battery when the external terminal 20 opens. In other words, the external terminal 20 opens more reliably when the pressure value substantially reaches a certain constant value. Accordingly, it is possible to achieve high safety.

### EXAMPLES

A description is given of Examples of the present technology according to an embodiment.

The secondary battery of the present present disclosure described above in an embodiment including modification examples were fabricated, following which a battery characteristic was evaluated. In addition, some secondary batteries each as a comparative example were fabricated, and were each evaluated for a battery characteristic.

### Fabrication of Secondary Battery

### Example 1

First, as Example 1, the secondary battery illustrated in FIG. 2 was fabricated in the following manner.

### [Fabrication of Positive Electrode]

First, 91 parts by mass of a positive electrode active material (LiCoO₂), 3 parts by mass of a positive electrode binder (polyvinylidene difluoride), and 6 parts by mass of a positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on the two opposed surfaces of the positive electrode current collector 41A (a band-shaped aluminum foil having a thickness of 12 μm) by a coating apparatus, following which the applied positive electrode mixture slurry was dried to thereby form the positive electrode active material layers 41B. Lastly, the positive electrode active material layers 41B were compression-molded by a roll pressing machine. In this manner, the positive electrode 41 (having a width of 3.3 mm) was fabricated.

### [Fabrication of Negative Electrode]

First, 95 parts by mass of a negative electrode active material (graphite) and 5 parts by mass of a negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on the two opposed surfaces of the negative electrode current collector 42A (a band-shaped copper foil having a thickness of 15 μm) by a coating apparatus, following which the applied negative electrode mixture slurry was dried to thereby form the negative electrode active material layers 42B. Lastly, the negative electrode active material layers 42B were compression-molded by a roll pressing machine. In this manner, the negative electrode 42 (having a width of 3.8 mm) was fabricated.

### [Preparation of Electrolytic Solution]

An electrolyte salt (LiPF₆) was added to a solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. As a result, the electrolytic solution was prepared.

### [Assembly of Secondary Battery]

First, the positive electrode lead 51 including aluminum was welded to the positive electrode 41 (the positive electrode current collector 41A) by the resistance welding method. The positive electrode lead 51 had a thickness of 0.1 mm, a width of 2.0 mm, and a protruding length of 11.7 mm from the positive electrode 41, and was partially covered at the periphery thereof by the sealant 61 having a tubular shape. The sealant 61 was a polypropylene film and had an outer diameter of 9.0 mm and an inner diameter of 3.0 mm. Further, the negative electrode lead 52 including nickel was welded to the negative electrode 42 (the negative electrode current collector 42A) by the resistance welding method. The negative electrode lead 52 had a thickness of 0.1 mm, a width of 2.0 mm, and a protruding length of 6.0 mm from the negative electrode 42. In this case, a welding position of the positive electrode lead 51 was so adjusted that the welding position of the positive electrode lead 51 was in the middle of winding of the positive electrode 41.

Thereafter, the positive electrode 41 and the negative electrode 42 were stacked on each other with the separator 43 interposed therebetween. The separator 43 was a fine-porous polyethylene film having a thickness of 25 μm and a width of 4.0 mm. Thereafter, the stack of the positive electrode 41, the negative electrode 42, and the separator 43 was wound to thereby fabricate the wound body 40Z having a cylindrical shape. The wound body 40Z had an outer diameter of 11.6 mm. The wound body 40Z had the winding center space 40K. The winding center space 40K had an inner diameter of 2.0 mm.

Thereafter, a ring-shaped insulating film for underlayment was placed into the container part 11 through the opening 11K. The ring-shaped insulating film was a polyimide film and had an outer diameter of 11.6 mm, an inner diameter of 2.2 mm, and a thickness of 0.05 mm. The container part 11 had a cylindrical shape and included stainless steel (SUS316). The container part 11 had a wall thickness of 0.15 mm, an outer diameter of 12.0 mm, and a height of 5.0 mm. Thereafter, the wound body 40Z was placed inside the container part 11. In this case, the negative electrode lead 52 was welded to the container part 11 by the resistance welding method.

Thereafter, the external terminal 20 was prepared. The external terminal 20 had the recessed part 12H. The recessed part 12H had the through hole 12K having an inner diameter of 3.0 mm. The recessed part 12H had an inner diameter of 9.0 mm and a height of a stepped part of 0.3 mm. The external terminal 20 had a disk shape and included aluminum. The external terminal 20 had a wall thickness of 0.3 mm and an outer diameter of 7.2 mm. The external terminal 20 was so adjusted that the curving amount became +0.01 mm by being deformed by pressure application. Further, the cover part 12 having a disk shape and including stainless steel (SUS316) was prepared. The cover part 12 had a wall thickness of 0.15 mm and an outer diameter of 11.7 mm. An insulating resin was applied to the surface 12HS of the bottom part 10HB of the cover part 12, following which the external terminal 20 was placed on the insulating resin. Polyimide was used as the insulating resin. Thereafter, the external terminal 20 was subjected to the pressure application and pressed downward while the insulating resin was heated and melted, following which the insulating resin was cooled. As a result, the external terminal 20 was welded to the cover part 12 with use of the gasket 30 that is the cooled insulating resin.

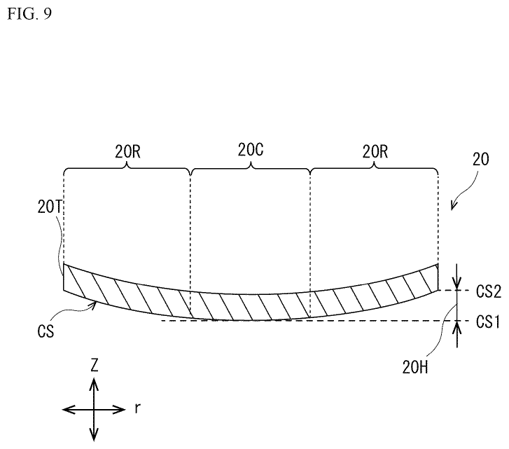

Thereafter, the positive electrode lead 51 was welded, by the resistance welding method, to the middle region 20C of the external terminal 20 that was attached to the cover part 12 with the gasket 30 interposed therebetween. As illustrated schematically in FIG. 9, the curving amount of the external terminal 20 referred to above means a protruding height 20H that is a difference between a position CS1, of the curved surface CS, closest to the battery device 40 in the height direction Z and a position CS2, of the curved surface CS, farthest from the battery device 40 in the height direction Z. The curving amount of the external terminal 20 being a positive numerical value means that the middle region 20C of the external terminal 20 protrudes more toward the battery device 40 than the peripheral region 20R of the external terminal 20. In other words, it means that the curved surface CS is in a state of being convex toward the battery device 40.

Thereafter, the electrolytic solution was injected into the container part 11 through the opening 11K in a state where the cover part 12 was raised relative to the container part 11. Thus, the wound body 40Z (including the positive electrode 41, the negative electrode 42, and the separator 43) was impregnated with the electrolytic solution, and the battery device 40 was fabricated.

Lastly, the opening 11K was closed with use of the cover part 12, following which the cover part 12 was welded to the container part 11 by the laser welding method. When the opening 11K was closed by the cover part 12, the turning part 513 was so formed in a portion of the positive electrode lead 51 as to form a curved shape. In addition, the insulating film 62 having a ring shape was disposed between the cover part 12 and the positive electrode lead 51, and the insulating film 63 having a disk shape was disposed between the battery device 40 and the positive electrode lead 51. The insulating film 62 was a polyimide film and had an outer diameter of 9.2 mm and an inner diameter of 3.2 mm. The insulating film 63 was a polyimide film and had an outer diameter of 3.2 mm. Thus, the outer package can 10 was formed with use of the container part 11 and the cover part 12, and the battery device 40 was sealed in the outer package can 10. As a result, the secondary battery was assembled. The secondary battery had an outer diameter of 12.0 mm and a height of 5.0 mm.

### [Stabilization of Secondary Battery]

The assembled secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours.

As a result, a film was formed on a surface of, for example, the negative electrode 42. This brought the secondary battery into an electrochemically stable state. The secondary battery of Example 1 was thus completed.

### Example 2

Thereafter, a secondary battery was fabricated as Example 2. Here, the curving amount of the external terminal 20 was set to +0.02 mm. Except for this difference, fabrication conditions of the secondary battery of Example 2 were similar to the fabrication conditions of the secondary battery of Example 1.

### Example 3

Thereafter, a secondary battery was fabricated as Example 3. Here, the curving amount of the external terminal 20 was set to +0.03 mm. Except for this difference, fabrication conditions of the secondary battery of Example 3 were similar to the fabrication conditions of the secondary battery of Example 1.

### Example 4

Thereafter, a secondary battery illustrated in FIG. 7 was fabricated as Example 4. Here, as illustrated in FIG. 7, the bottom part 12HB was inclined relative to the horizontal plane, along with the curved shape of the external terminal 20. Further, the curving amount of the external terminal 20 was set to +0.03 mm. Except for these differences, fabrication conditions of the secondary battery of Example 4 were similar to the fabrication conditions of the secondary battery of Example 1.

### Example 5

Thereafter, a secondary battery illustrated in FIG. 6 was fabricated as Example 5. Here, as illustrated in FIG. 6, the external terminal 20 was so curved that the curved surface CS that is opposed to the battery device 40 was the concave surface. Further, the curving amount of the external terminal 20 was set to −0.01 mm. Except for these differences, fabrication conditions of the secondary battery of Example 4 were similar to the fabrication conditions of the secondary battery of Example 1.

### Example 6

Thereafter, a secondary battery was fabricated as Example 6. Here, the curving amount of the external terminal 20 was set to −0.02 mm. Except for this difference, fabrication conditions of the secondary battery of Example 6 were similar to the fabrication conditions of the secondary battery of Example 5.

### Example 7

Thereafter, a secondary battery was fabricated as Example 7. Here, the curving amount of the external terminal 20 was set to −0.03 mm. Except for this difference, fabrication conditions of the secondary battery of Example 7 were similar to the fabrication conditions of the secondary battery of Example 5.

### Example 8

Thereafter, a secondary battery illustrated in FIG. 8 was fabricated as Example 8. Here, as illustrated in FIG. 8, the bottom part 12HB was inclined relative to the horizontal plane, along with the curved shape of the external terminal 20. Further, the curving amount of the external terminal 20 was set to −0.03 mm. Except for these differences, fabrication conditions of the secondary battery of Example 8 were similar to the fabrication conditions of the secondary battery of Example 5.

### Comparative Example 1

Thereafter, as Comparative example 1, a secondary battery including an external terminal that had a flat shape along the horizontal plane (i.e., did not have the curved shape) was fabricated. Except for employing the external terminal having the flat plate shape, fabrication conditions of the secondary battery of Comparative example 1 were similar to the fabrication conditions of the secondary battery of Example 1.

### [Evaluation of Battery Characteristic]

The secondary battery of each of Examples 1 to 8 and Comparative example 1 were each subjected to a cleavage strength test on a sealed portion at a room temperature and a heating test conforming to the UL1642 test to evaluate performance. The results are presented in Table 1. The number of samples of each of Examples and Comparative example was 10.

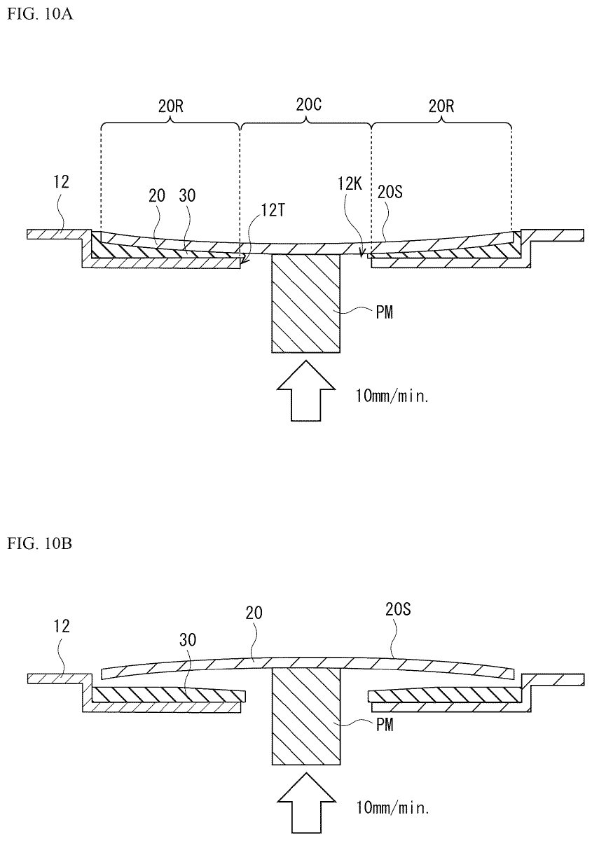

In the cleavage strength test on the sealed portion, the presence or absence of a cleavage of the gasket 30 as the sealed portion was determined. Specifically, as illustrated in FIG. 10A: a member in which the cover part 12 and the external terminal 20 were joined to each other with the gasket 30 interposed therebetween was taken out from each of the secondary batteries of Examples 1 to 8 and Comparative example 1 described above; and pressure was applied from a lower side toward an upper side on a surface, of the middle region 20C of the external terminal 20, on an opposite side to the surface 20S, by moving a pressing member PM at a constant velocity of 10 mm/min. The pressing member PM was a circular columnar rigid body whose bottom surface was a circle having a diameter of 3 mm. Therefore, an area of a contact surface between the pressing member PM and the middle region 20C of the external terminal 20 was 2.25×πmm². A maximum load to be applied to the external terminal 20 by the pressing member PM was set to 15 kg, and whether the cleavage occurred in the gasket 30, for example, as illustrated in FIG. 10B was observed.

In the heating test conforming to the UL1642 test, the temperature was increased to 130±2° C. at a heating rate of within a range from 20±5° C./min to 5±2° C./min, and whether the external terminal opened was determined when the temperature of 130±2° C. was maintained for 10 minutes.

TABLE 1

| | | | | Presence or | |
|---|---|---|---|---|---|
| | | | | absence of | |
| | | Curving amount | | cleavage in | Presence or |
| | Corresponding | of external | Orientation of | cleavage strength | absence of vent |
| | FIG. [mm] | terminal [mm] | curved surface | test | in heating test |
| Example 1 | FIG. 2 | +0.01 | Convex | 10/10 Absent | 2/10 Absent |
| | | | downward | | |
| Example 2 | FIG. 2 | +0.02 | Convex | 10/10 Absent | 0/10 Absent |
| | | | downward | | |
| Example 3 | FIG. 2 | +0.03 | Convex | 10/10 Absent | 0/10 Absent |
| | | | downward | | |
| Example 4 | FIG. 7 | +0.03 | Convex | 10/10 Absent | 0/10 Absent |
| | | | downward | | |
| Example 5 | FIG. 6 | −0.01 | Concave | 10/10 Absent | 3/10 Absent |
| | | | downward | | |
| Example 6 | FIG. 6 | −0.02 | Concave | 10/10 Absent | 2/10 Absent |
| | | | downward | | |
| Example 7 | FIG. 6 | −0.03 | Concave | 10/10 Absent | 1/10 Absent |
| | | | downward | | |
| Example 8 | FIG. 8 | −0.03 | Concave | 10/10 Absent | 1/10 Absent |
| | | | downward | | |
| Comparative | — | 0 | — | 10/10 Absent | 4/10 Absent |
| example 1 | | | | | |

As indicated in Table 1, in each of Examples 1 to 8 and Comparative example 1, the cleavage in the cleavage strength test occurred in none of the 10 samples. In the heating test, the external terminal did not open in four samples out of 10 samples in Comparative example 1, whereas it was possible to reduce the number of samples in which the external terminal did not open to three or less samples out of 10 samples in Examples 1 to 8. In particular, in each of Examples 2 to 4, the external terminal opened in all of the 10 samples.

Based upon the results presented in Table 1, it was confirmed that the curved shape of the external terminal allowed the external terminal to open easily when the pressure inside the battery reached a predetermined pressure value, and it was found that the secondary battery had higher safety, according to the secondary battery of the present present disclosure.

Although the present disclosure has been described hereinabove with reference to some embodiments and Examples, the configuration of the present disclosure is not limited to the configurations described in relation to the embodiments and Examples, and is therefore modifiable in a variety of ways.

Specifically, although the description has been given of the case where the outer package can is a welded can (a crimples can), the outer package can is not particularly limited in configuration, and may be a crimped can which has undergone crimping processing. In the crimped can, a container part and a cover part separate from each other are crimped to each other with a gasket interposed between the container part and the cover part.

Further, although the description has been given of the case where the electrode reactant is lithium, the electrode reactant is not particularly limited. Therefore, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other effect.

The present disclosure is described below in further detail according to an embodiment.

<1>

A secondary battery including:
a battery device including a stacked body, the stacked body including a first electrode and a second electrode, and being wound around a winding axis extending in a first direction;
an outer package member that has a through hole extending in the first direction, and contains the battery device; and
an external terminal that is attached to the outer package member with an insulating member interposed between the external terminal and the outer package member, the external terminal being provide at a position at which the external terminal overlaps the through hole of the outer package member in the first direction, in which
the external terminal has a curved shape including a concave surface or a convex surface facing toward the battery device.
   <2>

The secondary battery according to <1>, in which the external terminal includes a stacked body including two or more layers, the two or more layers having respective linear expansion coefficients that are different from each other.

<3>

The secondary battery according to <1>, in which the external terminal includes a stacked body, the stacked body including a first layer including Ni (nickel), a second layer including stainless steel, and a third layer including Al (aluminum).

<4>

The secondary battery according to any one of <1> to <3>, in which the outer package member includes
a cover part that has the through hole,
a bottom part that is opposed to the cover part with the battery device sandwiched between the bottom part and the cover part in the first direction, and
a sidewall part that couples the cover part and the bottom part to each other, and surrounds the battery device.
   <5>

The secondary battery according to <4>, in which
the cover part has a recessed part that is recessed toward the battery device along the first direction,
the through hole is provided in the recessed part of the cover part, and
the external terminal is contained in the recessed part without protruding from the recessed part in the first direction.
   <6>

The secondary battery according to <5>, in which
the recessed part includes an overlap region in which the recessed part overlaps a peripheral region of the external terminal in the first direction with the insulating member sandwiched between the recessed part and the peripheral region of the external terminal, and
the overlap region is inclined relative to a plane orthogonal to the first direction, along with the curved shape of the external terminal.
   <7>

The secondary battery according to any one of <1> to <6>, in which the insulating member includes a thin part having a small thickness in a radial direction along a plane orthogonal to the first direction.

<8>

The secondary battery according to <7>, in which the thin part is present in an annular shape on the plane.

<9>

The secondary battery according to any one of <1> to <8>, in which
the external terminal is electrically coupled to the first electrode, and
the outer package member is electrically coupled to the second electrode.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a battery device including a stacked body, the stacked body including a first electrode and a second electrode, and being wound around a winding axis extending in a first direction;
an outer package member that has a through hole extending in the first direction, and contains the battery device; and
an external terminal that is attached to the outer package member with an insulating member interposed between the external terminal and the outer package member, the external terminal being provided at a position at which the external terminal overlaps the through hole of the outer package member in the first direction, wherein
the external terminal has a curved shape including a concave surface or a convex surface facing toward the battery device.

2. The secondary battery according to claim 1, wherein the external terminal comprises a stacked body including two or more layers, the two or more layers having respective linear expansion coefficients that are different from each other.

3. The secondary battery according to claim 1, wherein the external terminal comprises a stacked body, the stacked body including a first layer including Ni (nickel), a second layer including stainless steel, and a third layer including Al (aluminum).

4. The secondary battery according to claim 1, wherein the outer package member includes
a cover part that has the through hole,
a bottom part that is opposed to the cover part with the battery device sandwiched between the bottom part and the cover part in the first direction, and
a sidewall part that couples the cover part and the bottom part to each other, and surrounds the battery device.

5. The secondary battery according to claim 4, wherein
the cover part has a recessed part that is recessed toward the battery device along the first direction,
the through hole is provided in the recessed part of the cover part, and
the external terminal is contained in the recessed part without protruding from the recessed part in the first direction.

6. The secondary battery according to claim 5, wherein
the recessed part includes an overlap region in which the recessed part overlaps a peripheral region of the external terminal in the first direction with the insulating member sandwiched between the recessed part and the peripheral region of the external terminal, and
the overlap region is inclined relative to a plane orthogonal to the first direction, along with the curved shape of the external terminal.

7. The secondary battery according to claim 1, wherein the insulating member includes a thin part having a small thickness in a radial direction along a plane orthogonal to the first direction.

8. The secondary battery according to claim 7, wherein the thin part is present in an annular shape on the plane.

9. The secondary battery according to claim 1, wherein
the external terminal is electrically coupled to the first electrode, and
the outer package member is electrically coupled to the second electrode.
